(19) United States
(12) Patent Application Publication
(10) Pub. No.: US 2006/0056567 A1
(43) Pub. Date: Mar. 16, 2006

(54) Method for loading nuclear fuel assemblies inside a nuclear plant reactor core and device therefor

(75) Inventor: Michel Jullien, Lucenay (FR)

Correspondence Address: HESLIN ROTHENBERG FARLEY & MESITI PC, 5 COLUMBIA CIRCLE, ALBANY, NY, 12203, US

(73) Assignee: FRAMATOME ANP., Courbevoie (FR)

(21) Appl. No.: 11/098,819

(22) Filed: Apr. 5, 2005

Related U.S. Application Data
(63) Continuation of application No. PCT/FR03/03043, filed on Oct. 15, 2003.

(30) Foreign Application Priority Data
Oct. 15, 2002 (FR) 02.12769

(51) Int. Cl. G21C 19/00

(52) U.S. Cl. 376/268

(57) ABSTRACT

A method for loading nuclear fuel assemblies inside a nuclear plant reactor core includes positioning at a second diagonal of a core plate, a triple guide module using an auxiliary mast of a loading machine or of a handling member designed therefor. Then, at least at each of the next diagonals of the core plate, positioning a guide module consisting of six consecutive guide tiles diagonally mounted so as to enable one to seven fuel assemblies to be installed one by one. Then, at an angle opposite to the initial angle for positioning the assemblies, positioning at the penultimate diagonal, the triple guide module, and two single-unit guide modules, so as to enable six fuel assemblies to be installed at the penultimate diagonal. Then, positioning the two single-unit guide modules at the last diagonal, so as to enable five fuel assemblies to be installed at the penultimate diagonal; and finally, after removing the single-unit guide modules, installing the last two nuclear fuel assemblies in the two remaining locations.

The invention relates to a method for loading nuclear fuel assemblies inside a reactor core of a nuclear plant.

The invention also relates to a device for implementing this method.

In known manner, the reactor core of a nuclear plant consists of a plurality of nuclear fuel assemblies, placed side by side on a support plate called a “core plate”.

Such a plate has a plurality of locations, usually square in shape, placed side by side in a regular, substantially octagonal geometric shape.

Each of the fuel assemblies is placed on a precise location, which for this purpose has male positioning lugs, and holes or orifices for circulation of a liquid coolant, and particularly of water.

The number of these fuel assemblies depends on the power of the reactor.

Conventionally, the reactor core is loaded from the top level of a cavity, by means of a refueling machine capable of moving above said cavity. The assemblies are positioned singly, next to one another, on the core plate using a vertical telescopic mast actuated from the refueling machine, the end of said mast being provided with a grab gripping the top end of said fuel assemblies.

One of the major problems that the operators of such nuclear plants face lies in the relatively long periods needed to change a reactor core, given the multiplicity of operations to carry out.

It is not in fact rare for the changing of a reactor core to require the shutdown of the plant for a period of several weeks, limiting in like measure the production of electric power.

This period linked to the loading and unloading of the reactor is inherent not only in the actual handling of the fuel assemblies, but also in positioning them precisely on the core plate.

For this purpose, a guidance module has been developed, having a dimension substantially corresponding to that of each of the assemblies, which is positioned on the core plate and more specifically, in a location immediately adjacent to the location in question of the assembly to be installed, this module notably being intended to provide the guidance at the end of travel of said assembly on the appropriate lugs of the corresponding location.

These modules are installed by the main mast of the refueling machine, that is to say the mast performing the actual handling of the fuel assemblies. Said module is therefore put in place prior to the loading of the assembly in question. The operation is thus repeated for practically all the locations of the reactor core.

To optimize this loading method, there has been a suggestion (for example in document FR-A-2 704 085) to use multiple guidance modules thus making it possible to reduce the number of movements of said module inside the core plate. Nevertheless, such multiple modules cannot be used to fully load the reactor core, requiring multiple single installations of assemblies, particularly on the periphery of the core, significantly increasing the loading time.

It has also been proposed to guide the free end of the assemblies at the end of travel by means of an automatic device which moves alone on the core plate. This device, which certainly makes it possible to work in concurrent operating time, and to go into the corners of the core plate is unfortunately costly, high in maintenance and dosimetry and may also sometimes cause reliability problems.

The objective of the present invention is fundamentally to allow the loading of the whole of a nuclear reactor core while reducing the nonproductive time of the plant.

This method for loading the core of a nuclear reactor with nuclear fuel assemblies on a core plate, said assemblies being of prismatic shape and of square cross-section, being positioned on a plurality of adjacent locations of square cross-section, each comprising male positioning lugs and female holes for circulation of a liquid coolant, and particularly of water, a method in which the nuclear fuel assemblies are installed by means of a handling tool called a refueling machine and by means of removable guidance modules, capable of being positioned at each of the locations of the core plate, is characterized in that it consists in:
positioning on the second diagonal of the core plate a triple guidance module by means of the auxiliary mast of the refueling machine or of a movement member intended specifically for the purpose and thus allowing the installation of two fuel assemblies in the first diagonal of said locations;
then positioning on each of the following diagonals of the core plate, by means of the main mast of the refueling machine or of the dedicated member a guidance module consisting of six consecutive guidance paving blocks mounted diagonally, so as to allow the installation of one to seven fuel assemblies one by one, diagonal by diagonal and moving said module along one and the same diagonal to arrive at the full length of the latter;
then, at the corner opposite the corner at which the positioning of the assemblies started, positioning the triple guidance module on the penultimate diagonal by means of the auxiliary mast, and two single-unit guidance modules by means of the auxiliary mast of the refueling machine or of the dedicated member, so as to allow the installation of six fuel assemblies on the antipenultimate diagonal;
then positioning the two single-unit guidance modules by means of the auxiliary mast of the refueling machine or of the dedicated member on the last diagonal, in order to allow the installation of the five fuel assemblies in the penultimate diagonal,
and finally, after removing the guidance module, installing the last two nuclear fuel assemblies at the two remaining locations, for which no assistance is possible.

In other words, the invention consists in using three types of guidance modules and in providing their handling on the one hand on the main mast of the refueling machine or on a movement member dedicated to the purpose, also called Z1, intended, as has already been said, to provide the handling of the fuel assemblies, and an auxiliary mast, called Z3, associated with the refueling machine or with said dedicated member, and intended to install the single-unit guidance modules or the triple module.

This auxiliary mast is conventionally present on refueling machines for plants of 1300 and 1450 MW power and is usually intended to allow the swapping of the clusters and of the plugs present in the top part of the reactor core.

This mast, according to the invention, undergoes an adaptation in terms of length, in order to allow the handling of the single-unit guidance module at the bottom of the reactor core, and on the other hand to furnish its free end with a grab suitable for being adapted to said guidance module.

So doing, it becomes possible, according to the method of the invention, to use such modules to guide the loading of 100% of a reactor core.

The invention also relates to the device for implementing this method. According to the invention, this device incorporates a refueling machine furnished with a main mast for handling nuclear fuel assemblies, and with at least one auxiliary mast and comprises three different types of modules, respectively single-unit guidance modules, a triple module used for the guidance of at least two fuel assemblies and finally a guidance module with six paving blocks intended to allow the installation of one to seven fuel assemblies.

These guidance modules are of the type described in the aforementioned document FR-A-2 704 085, the content of which is incorporated into the present patent application by reference. Each single-unit module has, on the one hand, on its bottom face intended to come into contact with the core plate, orifices intended to interact with positioning pins, and, on the other hand, two vertical adjacent walls connected to an inclined guidance portion. Such modules may be assembled in numbers, respectively in threes or in sixes in order to form an assembly, said modules being joined together by one of their tops in quincunx, corresponding to a diagonal of said core plate.

The means of assembling the single-unit modules typically consists of a bracket, formed of two wings, respectively a horizontal wing for connecting the modules together, and a vertical stiffening wing.

The manner of embodying the invention and the advantages that derive therefrom will better emerge from the following exemplary embodiment given for information only and nonlimiting in support of the appended figures.

FIGS. 1 to 8 illustrate the implementation of the method according to the invention, and represent in particular the different locations of a reactor core, in this instance with a power of 1300 Megawatts.

In the example described, the core plate comprises 193 locations, of square cross-section, each intended to receive a nuclear fuel assembly. These locations are distributed substantially in an octagon. According to the main dimensions there are 15 locations, respectively numbered vertically from 1 to 15 and horizontally from A to R.

First of all (FIG. 1) a triple guidance module (1) is installed, that is to say a module provided with three guidance paving blocks, on the diagonal B4-C3-D2 of the core plate, by means of the auxiliary mast of the refueling machine. Each of the guidance paving blocks corresponds to the dimension of a core plate location.

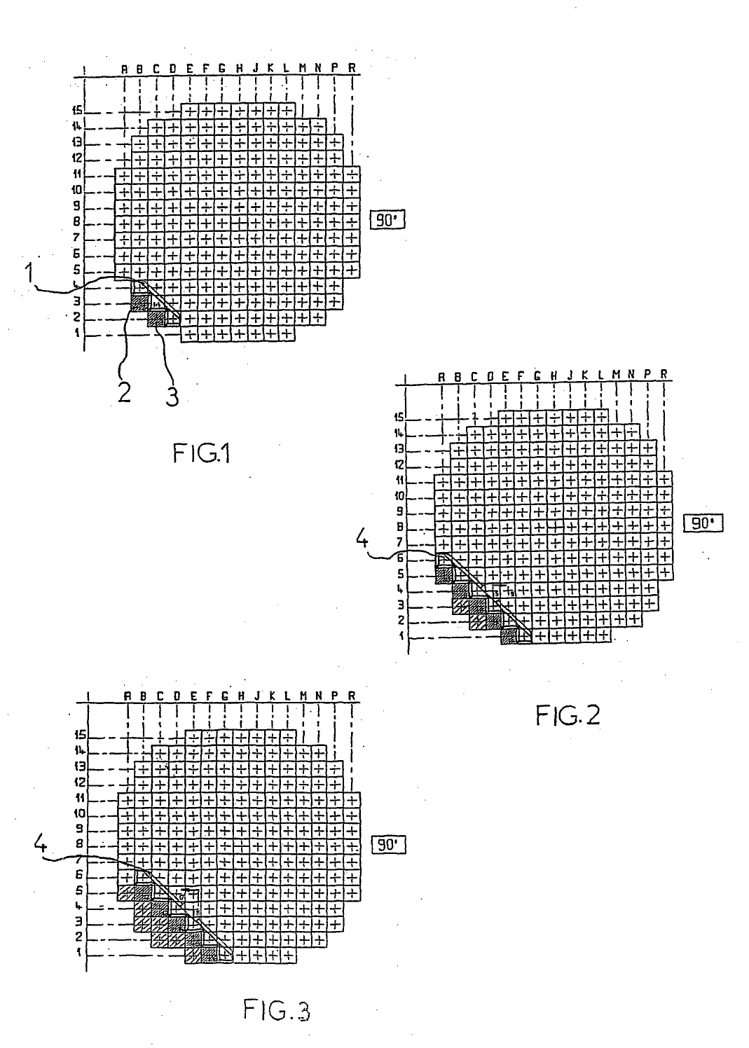

When this guidance module has been installed, two fuel assemblies (2, 3) are installed one by one in locations C2 and B3, the guidance then being performed by means of said triple module (FIG. 2).

Then, after retraction of the triple module (1), a module (4) consisting of six guidance paving blocks is installed on the diagonal beginning at A6 and terminating at F1 (FIG. 2), using the main mast, conventionally called Z1 of the refueling machine.

Then the fuel assemblies are installed one by one on the diagonal A5-E1 (FIG. 2).

The module (4) consisting of six guidance paving blocks is shifted to the next diagonal and the procedure continues by positioning six fuel assemblies one by one (FIG. 3). Said module (4) is shifted on the same diagonal (see arrow) in order to allow the guidance and positioning of the last assembly on that diagonal at A6 (see FIG. 4).

These various operations are repeated by shifting the module (4) consisting of six guidance paving blocks, moving in total respectively 39 times and allowing the insertion of 178 fuel assemblies (FIG. 5). To do this, said guidance module (4) is moved from once to three times for each of the diagonals in which it is implemented.

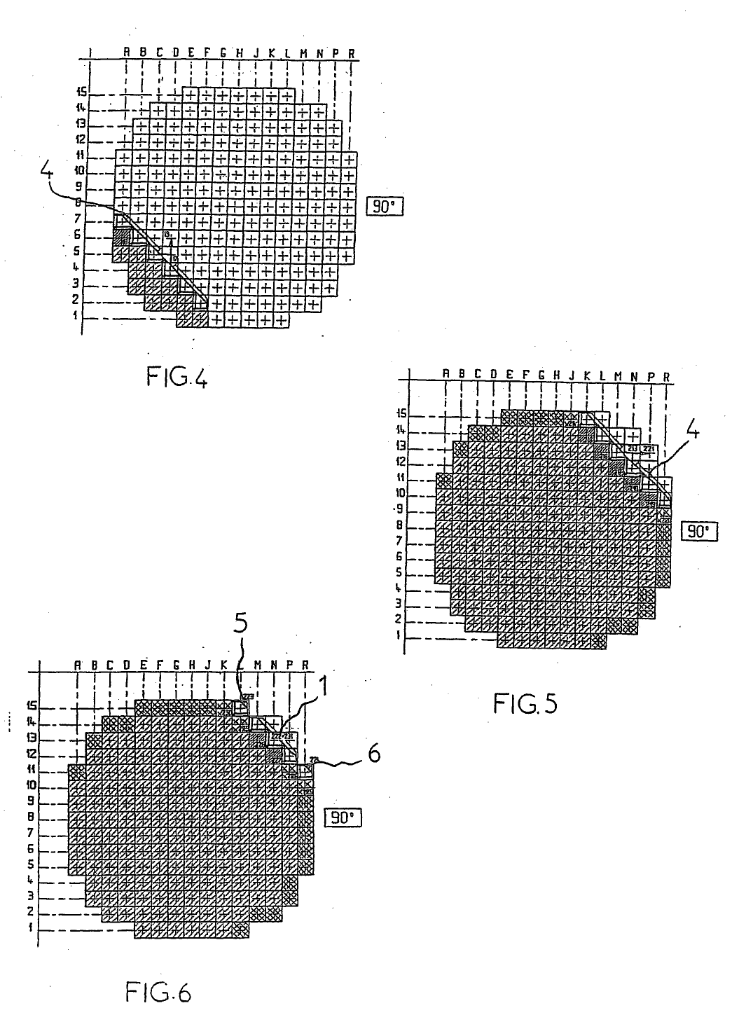

To install the fuel assemblies on the last three diagonals, the procedure is performed in the following manner (FIGS. 6 to 8).

First of all, the aforementioned triple module (1) is installed on the diagonal M14-P12, using the auxiliary mast of the refueling machine, and on the two ends of this diagonal at L15 and R11, two single-unit guidance modules (5, 6) are positioned also using the auxiliary mast Z3 of the refueling machine. Then six fuel assemblies are installed on the diagonal K15-R10 (FIG. 6).

During the next step, the triple guidance module (1) is removed and the two single-unit guidance modules (5, 6) are positioned on the ends N14 and P13 (FIG. 7), still by means of the auxiliary mast Z3 of the refueling machine, and the five fuel assemblies are installed on the diagonal L15-R11.

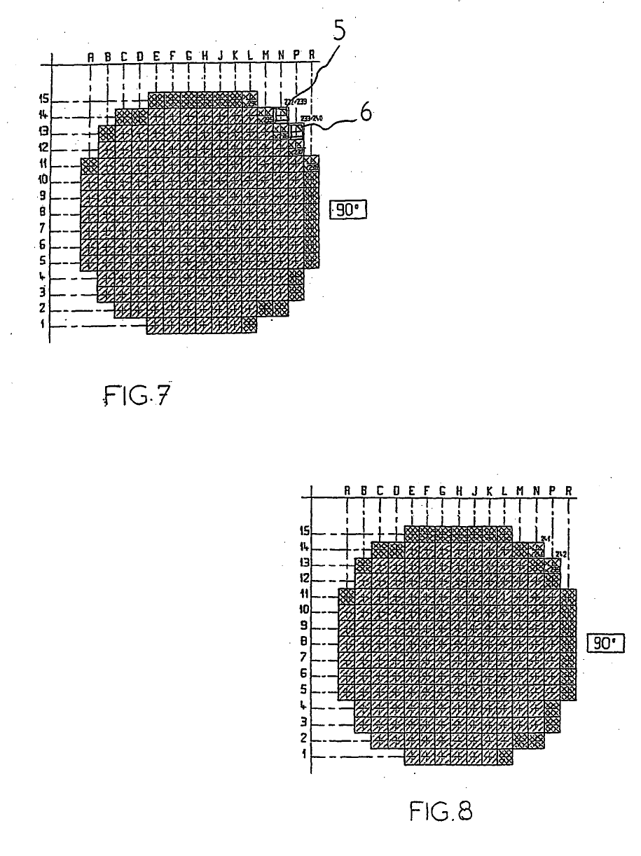

Then these two single-unit guidance modules (5, 6) are removed and the last two fuel assemblies are installed in their position, therefore at N14 and P13 (FIG. 8). Therefore all the value of the method of loading the reactor core according to the invention is evident.

First of all, due to the reduction in the number of guidance modules (three) to be used, and above all by minimizing the use of the single-unit guidance modules, considerable time is saved for the full loading of the reactor core.

This reduces the number of handling operations and the risks associated therewith.

These loading operations make it possible to achieve a considerable time saving, since typically, the time needed to load the core of a 1300 MW reactor is, with the method of the invention, less than 32 hours, therefore making it possible to reduce periods during which the plant is shut down and therefore optimizing the corresponding production of electric energy.

1. A method for loading a core of a nuclear reactor with nuclear fuel assemblies on a core plate, said assemblies being of prismatic shape and of square cross-section, being positioned on a plurality of adjacent locations of square cross-section, each comprising male positioning lugs and female holes for circulation of a liquid coolant, and particularly of water, and in which the nuclear fuel assemblies are installed by means of a handling tool called a refueling machine and by means of removable guidance modules, capable of being positioned at each of the locations of the core plate, comprising:
positioning on a second diagonal of the core plate a triple guidance module by means of an auxiliary mast of the refueling machine or of a dedicated movement member intended specifically for the purpose and thus allowing the installation of two fuel assemblies in the first diagonal of said locations;
then positioning on each of following diagonals of the core plate, by means of a main mast of the refueling machine or of the dedicated member, a guidance module comprising six consecutive guidance paving blocks mounted diagonally, so as to allow the installation of one to seven fuel assemblies one by one, diagonal by diagonal and moving said module along one and the same diagonal to arrive at a full length of the latter;
then, at a corner opposite a corner at which the positioning of the assemblies started, positioning the triple guidance module on a penultimate diagonal by means of the auxiliary mast of the refueling machine or of the dedicated member, and two single-unit guidance modules also by means of the auxiliary mast of the refueling machine or of the dedicated member, so as to allow installation of six fuel assemblies on an antipenultimate diagonal;
then positioning the two single-unit guidance modules by means of the auxiliary mast of the refueling machine or of the dedicated member on a last diagonal, in order to allow installation of five fuel assemblies on the penultimate diagonal,
and finally, after removing the single-unit guidance modules, installing last two nuclear fuel assemblies in two remaining locations.

2. The method for loading the core of a nuclear reactor as claimed in claim 1, wherein the guidance module comprising six guidance paving blocks is moved one to three times for each of the diagonals in which it is implemented.

3. A device for installing nuclear fuel assemblies inside a core of a nuclear reactor, said assemblies being of prismatic shape and of square cross-section, being positioned on a plurality of adjacent locations of square cross-section, each comprising male positioning lugs and female holes for circulation of a liquid coolant, and particularly of water, comprising; a refueling machine provided with a main mast for handling said nuclear fuel assemblies, also for handling removable guidance modules, capable of being positioned in each of locations of a core plate, and further comprising at least one auxiliary mast, also operated by the refueling machine, and wherein the device comprises three different types of modules, respectively two single-unit guidance modules, a triple guidance module allowing guidance of at least two fuel assemblies and finally a module with six guidance paving blocks intended to allow installation of one to seven fuel assemblies.

4. The device for installing nuclear fuel assemblies inside the core of a nuclear reactor as claimed in claim 3, wherein the single-unit guidance modules and the triple guidance module are handled by means of an auxiliary mast of the refueling machine, and wherein the guidance module with six guidance paving blocks is handled by the main mast of said refueling machine.

5. A device for installing nuclear fuel assemblies inside a core of a nuclear reactor, said assemblies being of prismatic shape and of square cross-section, being positioned on a plurality of adjacent locations of square cross-section, each comprising male positioning lugs and female holes for circulation of a liquid coolant, and particularly of water, comprising a movement member dedicated to the handling of guidance modules, provided with a main mast for handling one of removable guidance modules and an auxiliary mast for handling other removable guidance modules, said guidance modules being capable of being positioned in each of locations of a core plate, wherein the device comprises three different types of modules, respectively two single-unit guidance modules, a triple guidance module allowing guidance of at least two fuel assemblies and finally a module with six guidance paving blocks intended to allow installation of one to seven fuel assemblies.

6. The device for installing nuclear fuel assemblies inside the core of a nuclear reactor as claimed in claim 5, wherein the single-unit guidance modules and the triple guidance module are handled by means of the auxiliary mast of the dedicated movement member, and in that the guidance module with six guidance paving blocks is handled by the main mast of said dedicated movement member.

7. The device for installing nuclear fuel assemblies inside the core of a nuclear reactor as claimed in one of claims 3 to 6, wherein each single-unit module has, on one hand, on its bottom face intended to come into contact with the core plate, orifices intended to interact with positioning pins, and, on the other hand, two vertical adjacent walls connected to an inclined guidance portion.

8. The device for installing nuclear fuel assemblies inside the core of a nuclear reactor as claimed in claim 7, wherein the single-unit guidance modules are capable of being assembled in numbers, respectively in threes or in sixes in order to form an assembly, said modules being joined together by one of their tops in quincunx, corresponding to a diagonal of said core plate.

9. The device for installing nuclear fuel assemblies inside the core of a nuclear reactor as claimed in claim 8, further comprising a means of assembling the single-unit modules comprising a bracket, formed of two wings, respectively a horizontal wing for connecting the modules together, and a vertical stiffening wing.
